(19) United States
(12) Patent Application Publication
(10) Pub. No.: US 2024/0353736 A1
(43) Pub. Date: Oct. 24, 2024

(54) OPTICAL APERTURE HAVING A NON-CIRCULAR OPENING AND OPTICAL SYSTEM INCLUDING SUCH APERTURE

(71) Applicant: CE HOLDING GmbH, Hutthurm (DE)

(72) Inventors: Klaus ECKERL, Freyung (DE); Uwe ECKERL, Freyung (DE)

(21) Appl. No.: 18/627,014

(22) Filed: Apr. 4, 2024

(30) Foreign Application Priority Data
Apr. 4, 2023 (DE) 102023108644.8

(51) Int. Cl. G03B 9/06

(52) U.S. Cl. CPC G03B 9/06

(57) ABSTRACT

An aperture having a non-circular aperture comprises a first ring and a second ring rotatable relative to each other, and a plurality of blades, wherein edges of the blades define the aperture. The diaphragm includes a plurality of joints, wherein each joint pivotably connects one blade to the first ring. The diaphragm further comprises a plurality of grooves, wherein a number of the grooves corresponds with the number of the blades, wherein the grooves are provided on the second ring, wherein a connector is provided on each blade, wherein the connector engages with the groove and is moveable along the groove. The joints are positioned at varying distances in the circumferential direction about the rotation axis. Moreover, the edges of the blades defining the aperture have different shapes.

### RELATED APPLICATIONS

This application is related to the German patent application no. 10 2023 108 644.8 entitled “OPTICAL DIAPHRAGM HAVING A NON-CIRCULAR APERTURE AND OPTICAL SYSTEM HAVING SUCH DIAPHRAGM”, the whole content of which is incorporated herein by reference.

### TECHNICAL FIELD

The present invention relates to an optical diaphragm having a non-circular aperture, and to a system having such diaphragm.

### DISCUSSION OF THE BACKGROUND

Optical diaphragms having a circular aperture and having an adjustable diameter are provided in many optical systems, such as movie cameras and still cameras. The diaphragms are used to adjust the depth of focus of an imaging of an object onto a film or image sensor, and to adjust the amount of light reaching the film and image sensor, respectively. When the diaphragm has a smaller diameter of the aperture, the depth of focus is larger and the amount of light is smaller, resulting in the greater exposure time, while the bigger diameter of the aperture results in a smaller depth of focus and a shorter exposure time.

Some artists appreciate a property of an optical imaging referred to as bokeh which describes the appearance of unsharp or blurred regions in an image. The diaphragm in a lens barrel can be used to control the bokeh in a movie or still camera. It has been found that diaphragms having non-circular apertures can produce a bokeh which is interesting from an artist's point of view.

However, diaphragms having non-circular apertures of an adjustable diameter are not readily available.

### SUMMARY OF THE INVENTION

Accordingly, it is an object of the present invention, to provide a diaphragm having a non-circular aperture of an adjustable diameter and which is not difficult to manufacture.

According to the invention, a diaphragm having a non-circular aperture has a first ring, a second ring and a plurality of blades. The blades are mounted between the first ring and the second ring, and edges of the blades define the aperture provided by the diaphragm. The second ring is rotatable relative to the first ring about a rotation axis. The rotation of the two rings relative to each other results in a displacement of the plurality of blades relative to each other, such that the diameter of the aperture provided by the blades can be adjusted by rotating the two rings relative to each other.

The diaphragm comprises a plurality of joints, wherein a number of the joints corresponds to the number of the blades. Each joint connects one of the blades with the first ring such that the blade is mounted on the first ring to be pivotable about a pivot axis.

The diaphragm further comprises a plurality of grooves provided in the second ring, wherein the number of grooves corresponds to the number of the blades, and wherein each blade is provided with a connector engaging with one groove and being movable along the groove.

According to exemplary embodiments, the joints are distributed in the circumferential direction about the rotation axis, wherein distances between adjacent pivot axes of the joints in the circumferential direction about the rotation axis vary between the joints. This means that the joints are not disposed at equal distances about the rotation axis. In the conventional diaphragm having a circular aperture, the pivot axes of the joints are uniformly distributed in the circumferential direction about the rotation axis. Using the arrangement of the joints at varying distances between immediately adjacent joints in the circumferential direction, it is possible to adjust the pivoting motion of the blades upon relative rotation of the two rings such that some of the blades pivot faster or slower than other blades, such that the edges of the blades defining the aperture are located at different distances from the center of the aperture such that the aperture defined by the edges of the blades has a non-circular shape.

The varying distances between the pivot axes of adjacent joints in the circumferential direction can be designed such that a ratio between a largest distance among the distances between circumferentially adjacent pivot axes and a smallest distance among the distances between the circumferentially adjacent pivot axes is greater than 1.05 and in particular greater than 1.10.

According to exemplary embodiments, shapes of the edges of the blades defining the shape of the aperture in at least one rotational position of the first ring relative to the second ring vary between blades. This means that the edge of the blade defining the aperture does not have a same shape between the plurality of edges of the blades. In the conventional diaphragm having a circular aperture, the edges of all blades have a same shape. In the present embodiment, the shapes of the edges defining the aperture are designed such that the varying curvatures of the edges define the non-circular aperture. Moreover, the edges of the blades have different portions contributing to defining the aperture at different rotational positions between the two rings. The different portions may have different curvatures, such that a given blade defines a small aperture with a portion of its edge having a greater curvature than another portion of the same edge defining the greater aperture.

The different shapes of the blades can be, for example, designed such that there is at least one pair of blades for which the following is fulfilled: if the blades of the pair of blades are stacked with their main surfaces on a plane such that the pivot axes of the joints of the two blades coincide, and such that, when seen in an elevational view on this plane, the edges of the blades intersect at a given location, there is another location along the edges, where a distance between the edges of the blades is greater than 0.05 times a maximum diameter of the aperture, and in particular 1.10 times the maximum distance of the aperture.

According to exemplary embodiments, the grooves have varying shapes. This means that all grooves do not have the same shape. In the conventional diaphragm having a circular aperture, all grooves have a same shape.

By designing the grooves to have different shapes, the pivoting movement of the blades upon rotation of the two rings relative to each other can be achieved such that some blades move faster or slower than other blades, such that the edges of the blades defining the aperture are arranged at different distances from the center of the aperture, such that the aperture defined by the edges of the blades has a non-circular shape.

The different shapes of the grooves can be, for example, designed such that there is at least one pair of grooves for which the following is fulfilled: when the grooves are projected onto a drawing plane such that endpoints of the grooves coincide and edges of the groove intersect, there is a portion of the grooves where a distance between the edges of the two grooves is greater than 1.05 times a length of the two grooves and in particular 1.10 times the length of the two grooves.

The shape of the non-circular aperture may approach an elliptical shape. This means that the aperture of the diaphragm has a large diameter and a small diameter, wherein the large diameter and the small diameter are measured in different directions. A ratio between the length of the large diameter and the length of the small diameter can be regarded as the ellipticity of the aperture even if the shape of the aperture does not exactly correspond to the elliptical shape. According to exemplary embodiments, the ellipticity of the aperture is, at all rotational positions of the second ring relative to the first ring, greater than 1.2, greater than 1.4, greater than 2.0, greater than 2.4 or even greater.

According to exemplary embodiments herein, the ellipticity of the aperture, which can be greater than 1.2, is substantially the same for all rotational positions of the second ring relative to the first ring. This means that the ellipticity does not vary by more than 20% over all rotational positions of the first ring relative to the second ring. In particular, a ratio between the largest ellipticity of all rotational positions of the first ring relative to the second ring and a smallest ellipticity of all rotational positions of the first ring relative to the second ring can be smaller than 1.2 and in particular smaller than 1.1.

According to exemplary embodiments, a number of the blades of the diaphragm is six or greater than six. For example, eight, ten, twelve, fourteen or more blades can be provided. The number of blades can be an even number or an impair number.

According to exemplary embodiments, the diaphragm is designed such that an orientation of the large diameter of the aperture at a given rotational position of the first ring relative to the second ring does not change by more than 10° over all rotational positions.

Embodiments of the invention further provide an optical system having plural lenses providing a beam path of the optical system. This optical system also includes the above described diaphragm with its aperture in its beam path. By rotating the second ring relative to the first ring, the positions of the blades can be changed in order to change the diameter of the aperture resulting in a change in the configuration of the bundle of light rays traversing the optical system.

The geometrical configuration of the diaphragm can be defined by parameters. Some of these parameters can be used as free parameters in a suitable optimization method in order to be optimized to determine parameters of the diaphragm having desired geometric properties. It is thus possible to manufacture the diaphragm providing the desired properties using the determined parameters. The free parameters used in the optimization may in particular include the distances between the pivot axes, parameters describing the shapes of the edges of the blades defining the aperture in at least one rotational position of the first ring relative to the second ring, and parameters describing the shapes of the grooves.

### BRIEF DESCRIPTION OF THE DRAWINGS

Embodiments of the invention will be illustrate with reference to the drawings below.

FIG. 1 shows an optical system having a diaphragm according to an embodiment;

FIG. 2 is an elevational view of a first ring of the diaphragm shown in FIG. 1;

FIG. 3 is an elevational view of a second ring of the diaphragm shown in FIG. 1;

FIG. 4 is an elevational view of a blade having a first shape of the diaphragm shown in FIG. 1;

FIG. 5 is a side view of the blade having the first shape shown in FIG. 4;

FIG. 6 is an elevational view of a blade having a second shape of the diaphragm shown in FIG. 1;

FIG. 7 is an elevational view of a blade having a third shape of the diaphragm shown in FIG. 1;

FIG. 8 is an elevational view of a blade having a fourth shape of the diaphragm shown in FIG. 1;

FIG. 9 is an elevational view of the diaphragm shown in FIG. 1 when the second ring is removed; and

FIG. 10 is an illustration of different shapes of the blade of the first shape shown in FIG. 4 and of the blade of the second shape shown in FIG. 6.

### DESCRIPTION OF EMBODIMENTS

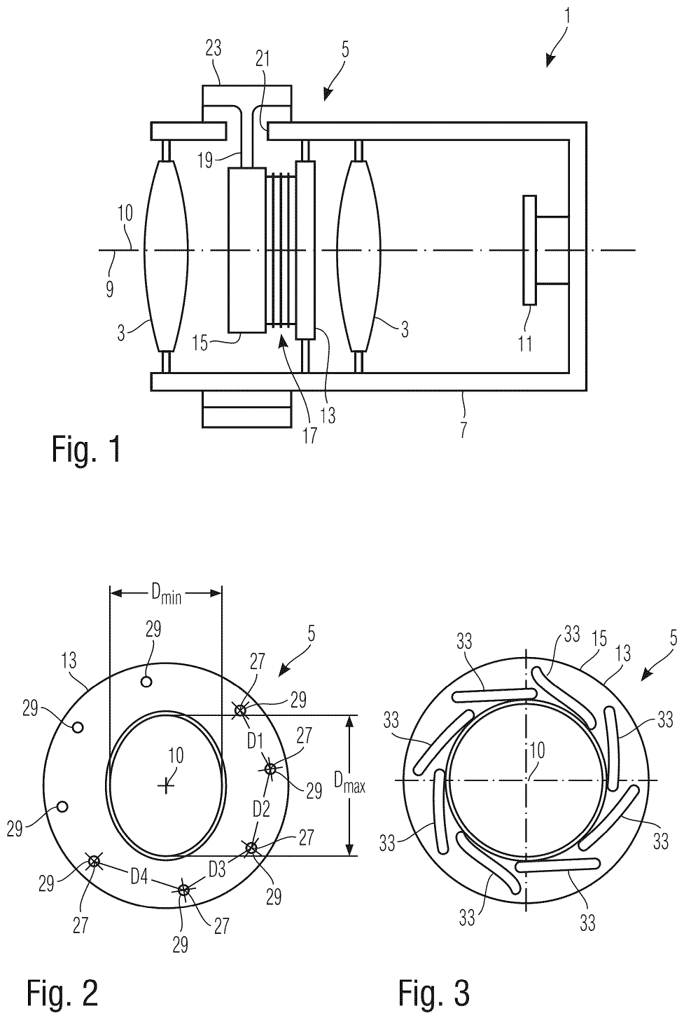

FIG. 1 is a schematic sectional view of an optical system 1 having a plurality of optical lenses 3 and a diaphragm 5 mounted in a housing 7. The lenses 3 and the diaphragm are disposed along a beam path and centered relative to an optical axis 9. The optical system 1 further comprises a light-sensitive image sensor 11 mounted on the housing 7 such that the optical system 1 provides a camera.

The diaphragm 5 comprises a first ring 13 and a second ring 15 on which a plurality of blades 17 are mounted, wherein the blades 17 define an aperture of the diaphragm 5. The first ring 13 is mounted on the housing 7 to be fixed in the circumferential direction about the optical axis 9, while the second ring 15 can be rotated relative to the first ring 13 about a rotation axis 10 which coincides with the optical axis 9 of the optical system 1. For this purpose, a projection 19 fixed to the second ring traverses a groove 21 in the housing 7 and carries an outer ring 23. The user of the optical system 1 may grasp the outer ring 23 and rotate the outer ring 23 relative to the housing 7 in order to achieve the rotation of the second ring 15 of the diaphragm 5 relative to the first ring 13 of the diaphragm 5.

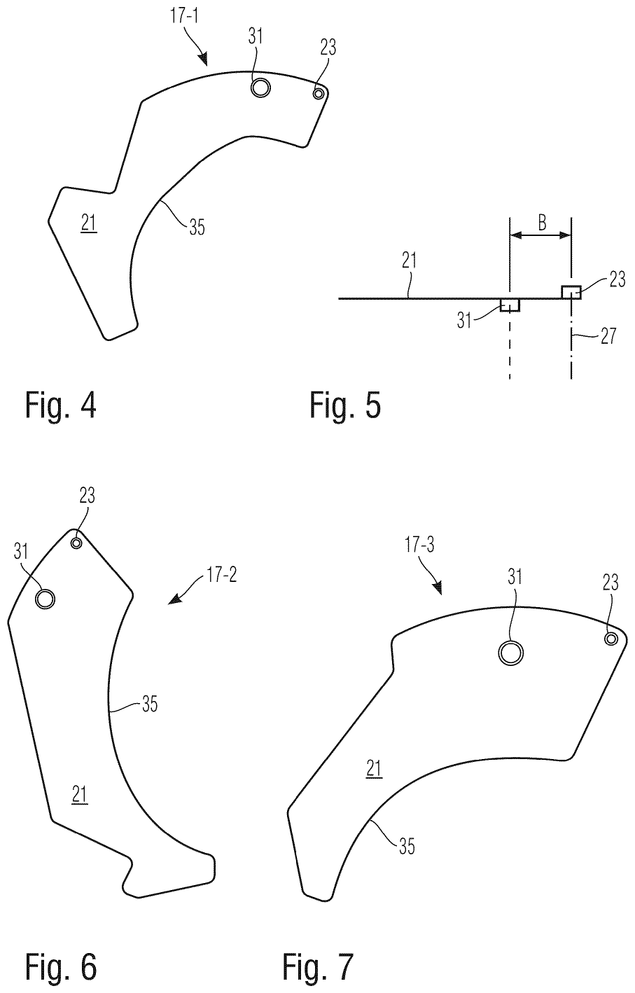

Details of the diaphragm 5 will be illustrated below with reference to FIGS. 2 to 9, wherein FIG. 2 is an elevational view of the first ring 13, FIG. 3 is an elevational view of the second ring 15, FIGS. 4 to 8 illustrate shapes of the blades 17, and FIG. 9 shows the partially mounted diaphragm 5.

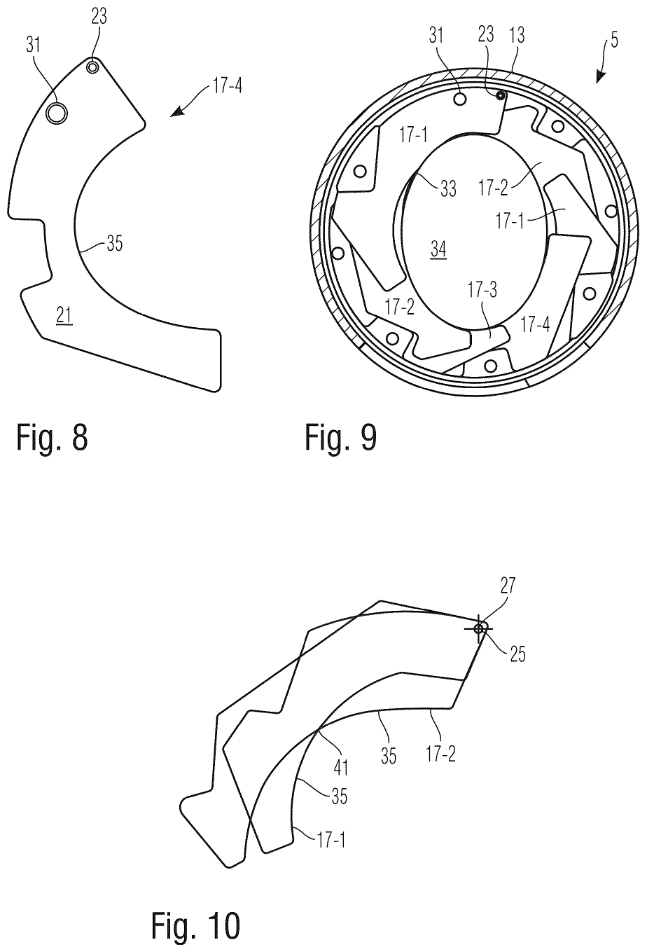

The diaphragm 5 has eight blades 17. The blades 17 different with respect to their shapes, wherein four different shapes are provided. An elevational view of a blade 17-1 of a first shape is shown in FIG. 4 while FIG. 5 shows a side view thereof. An elevational view of a blade 17-2 of a second shape is shown in FIG. 6; an elevational view of a blade 17-3 of a third shape is shown in FIG. 7, and an elevational view of a blade 17-4 of a fourth shape is shown in FIG. 8. The side views of the blade 17-2 of the second shape, the blade 17-3 of the third shape and the blade 17-4 of the fourth shape are not shown in the figures since they are similar to the side view of the blade 17-1 of the first shape shown in FIG. 5.

The blades 17-1, 17-2, 17-3 and 17-4 are each made of a thin metal sheet. A first stud 23 projects from one face of the blade 17. The stud 23 is one component of a joint 25 mounting the blade 17 on the first ring 13 such that the blade 17 is pivotable relative to the first ring 13 about a pivot axis 27. In the diaphragm 5, the studs 23 engage with holes 29 provided in the first ring 13.

A stud 31 projects from the face of the sheet 21 opposite to the stud 23, and is provided at a distance B from the stud 23. In the diaphragm 5, the stud 31 engages with a groove 33 provided on the second ring 15. The studs 13 provide connectors between the blades 17 and the second ring 15, wherein the connector is fixed to the blade 17, engages with the groove 33 and is movable along the groove 33. By rotating the second ring 15 relative to the first ring 13, the studs 13 are moved along the grooves 33, resulting in the blades being pivoted about their pivot axes 27. This also results in displacing of edges 35 of the blades 17 relative to the rotation axis 10. The edges 35 are those edges of the blades 17 defining an aperture 34 of the diaphragm 5 in at least one rotational position of the first ring 13 relative to the second ring 15.

FIG. 9 shows the partially mounted diaphragm 5 including the first ring 13, a portion of the blades 17, wherein the second ring 15 is removed, wherein one of the blades 17-3 is removed, and wherein one of the blades 17-4 is removed.

The blades 17 of different shapes have edges 35 of different shapes, while blades 17 of a same shape have edges 35 of a same shape. The differences between blades 17 of different shapes and the shapes of the edges 35 thereof will be described with reference to FIG. 10 below. FIG. 10 shows the blade 17-1 of the first shape and the blade 17-2 of the second shape stacked above each other such that the pivot axes 27 of the joints 25 thereof coincide and such that the edge 35 of the blade 17-1 and the edge 35 of the blade 17-2 intersect at a point 41. It is apparent from FIG. 10 that the edges 35 of the two blades 17-1 and 17-2 have increasing distances from each other when the distance from the point 41 increases. Specifically, a distance between the two edges 35 of the two blades 17-1 and 17-2 will become greater than 0.05 a maximum diameter Dmax of the aperture 34, and in particular greater than 1.1 times the maximum diameter Dmax of the aperture 34.

All pairs of the blades 17-1, 17-2, 17-3 and 17-4 of the first, second, third and fourth shapes, respectively, can be stacked, as described above, to recognize the different shapes of the edges 35 defining the aperture 34 in at least one rotational position of the second ring 15 relative to the first ring 13.

The diaphragm 5 comprises two blades 17-1 of the first shape, two blades 17-2 of the second shape, two blades 17-3 of the third shape and two blades 17-4 of the fourth shape, such that the total number of blades 17 is an even number and so that the number of the blades 17 having edges 35 of a same shape is an even number. Thus, two, four or six blades may have edges of a same shape. However, there are at least two, three, four or more blades of the diaphragm having edges of different shapes. It is, however, not required to have an even number of blades having edges of a same shape. It is possible that only one blade or three blades have edges of a same shape, and also the total number of blades of the diaphragm can be an impair number.

Apart from the blades 17 differing with respect to the shapes of the edges 35, the blades also differ with respect to positions of attachment of the blades on the first ring 13 by the joints 25.

The joints 25 of the blades 17 are not provided at equal distances in the circumferential direction on the first ring 13. Specifically, the holes 29 engaged by the studs 23 to provide the joints 25 are arranged with different distances in the circumferential direction about the rotation axis 10. FIG. 2 shows four different distances D1, D2, D3, and D4 between the pivot axes 27 of the individual joints 25. The arrangement of the pivot axes is symmetric relative to the rotation axis 10. In the illustrated example: D1=10.25 mm, D2=13.06 mm, D3=12.95 mm and D4=15.51 mm. A ratio between the greatest distance D4 among these distances and the smallest distance D1 among these distances is 1.51, which is greater than 1.05 and in particular greater than 1.10. In the most open position of the diaphragm, the largest diameter Dmax of the elliptical aperture is 24 mm, and the smallest diameter Dmin of the elliptical aperture is 18 mm. The ellipticity of the aperture 35, which is the ratio of Dmax and Dmin is, in the illustrated example, 1.33 which is greater than 1.2.

Also the grooves 33 engaged by the studs 31 have different shapes for blades 17 of different shapes, as shown in FIG. 3.

By providing the blades 17 with edges 35 of different shapes defining the aperture 34, by providing different distances between adjacent joints in the circumferential direction about the rotation axis 10, and also by providing different shapes of the grooves 23, it is possible to design the diaphragm such that the aperture has, irrespective of the size of the aperture, an elliptical shape, wherein the orientation of the main axis of the ellipse relative to the first ring 13 is substantially the same for all positions of the aperture.

1. A diaphragm having a non-circular aperture, comprising:
a first ring and a second ring rotatable relative to the first ring about a rotation axis;
a plurality of blades wherein edges of the blades define the aperture of the diaphragm wherein a number of the blades is greater than or equal to six;
a plurality of joints, wherein a number of the joints corresponds to the number of the blades, wherein each joint connects one of the blades to the first ring such that the blade is pivotable relative to the first ring about a pivot axis;
a plurality of grooves, wherein a number of the grooves corresponds to the number of the blades, wherein the grooves are provided on the second ring, wherein a connector is provided on each blade, wherein the connector engages with one of the grooves and is moveable along the groove;
wherein the joints are distributed around the rotation axis, wherein distances between pivot axes vary between joints adjacent to each other in the circumferential direction about the rotation axis, and/or
wherein the edges of the blades defining the aperture of the diaphragm in at least one rotational position of the first ring relative to the second ring differ with respect to their shapes.

2. The diaphragm according to claim 1,
wherein a ratio between a largest distance among the distances between the pivot axes of adjacent joints in the circumferential direction about the rotation axis and a smallest distance among the distances between pivot axes of adjacent joints in the circumferential direction about the rotation axis is greater than 1.05.

3. The diaphragm according to claim 1,
wherein there is at least one pair of blades which fulfills:
when the blades of the pair are stacked such that the pivot axes of the joints of the two blades coincide, and such that, when seen in an elevational view of the faces of the blades, the edges of the blades intersect at a location, there is a distance between the edges of the two blades at a distance from this location greater than 0.05 times a maximum diameter of the aperture.

4. The diaphragm according to claim 1,
wherein the edges of the blades defining the aperture of the diaphragm in at least one rotational position of the first ring relative to the second ring have different shapes, and
wherein a number of the blades having a same shape of their edges is an even number.

5. The diaphragm according to claim 1,
wherein the shapes of the grooves vary.

6. The diaphragm according to claim 1,
wherein the joints include at least one first stud provided on the blade, and a hole provided on the first ring, wherein the first stud engages with the hole provided on the first ring.

7. The diaphragm according to claim 1,
wherein the connector includes a second stud fixed to the blade and engaging with the groove.

8. The diaphragm according to claim 1,
wherein, in a given rotational position of the first ring relative to the second ring, an ellipticity of the aperture is given by a ratio between a large diameter of the aperture at the given rotational position and a small diameter of the aperture at the given rotational position, and
wherein the ellipticity of the aperture is, at all rotational positions of the first ring relative to the second ring, greater than 1.2.

9. The diaphragm according to claim 8,
wherein a ratio between the greatest ellipticity among all rotational positions of the second ring relative to the first ring and the smallest ellipticity among all rotational positions of the second ring relative to the first ring is smaller than 1.2.

10. The diaphragm according to claim 1,
wherein an orientation of a large diameter of the aperture at a given rotational position of the second ring relative to the first ring doesn't change by more than 10° over all rotational positions.

11. Optical system, comprising:
plural lenses and
a diaphragm positioned along a beam path of the optical system,
wherein the diaphragm comprises:
a first ring and a second ring rotatable relative to the first ring about a rotation axis;
a plurality of blades wherein edges of the blades define the aperture of the diaphragm wherein a number of the blades is greater than or equal to six;
a plurality of joints, wherein a number of the joints corresponds to the number of the blades, wherein each joint connects one of the blades to the first ring such that the blade is pivotable relative to the first ring about a pivot axis;
a plurality of grooves, wherein a number of the grooves corresponds to the number of the blades, wherein the grooves are provided on the second ring, wherein a connector is provided on each blade, wherein the connector engages with one of the grooves and is moveable along the groove;
wherein the joints are distributed around the rotation axis, wherein distances between pivot axes vary between joints adjacent to each other in the circumferential direction about the rotation axis, and
wherein the edges of the blades defining the aperture of the diaphragm in at least one rotational position of the first ring relative to the second ring differ with respect to their shapes.
